(19) United States
(12) Patent Application Publication
(10) Pub. No.: US 2012/0323606 A1
(43) Pub. Date: Dec. 20, 2012

(54) METHOD AND A MOBILE DEVICE FOR REVIEWING PATIENT INFORMATION

(76) Inventors: Anand Ananthasubramaniam, Singapore (SG); Bhanu Prakash Kirgaval Nagaraja Rao, Singapore (SG); Thirunavuukarasuu Arumugam, Singapore (SG); Guoliang Yang, Singapore (SG)

(21) Appl. No.: 13/580,662

(22) PCT Filed: Feb. 25, 2011
(86) PCT No.: PCT/SG2011/000078

§ 371 Date: Aug. 22, 2012

(30) Foreign Application Priority Data
Feb. 26, 2010 (SG) 201001347-2

(51) Int. Cl. G06Q 50/24

(52) U.S. Cl. 705/3

(57) ABSTRACT

A method is disclosed for reviewing at a mobile device patient information residing on a server, the method comprising the steps of receiving a message pushed from the server, the message having a resource identifier associated with the patient information, retrieving the patient information from the server using the resource identifier, displaying at least part of the retrieved patient information on a screen of the mobile device, reviewing the displayed patient information to obtain a comment, and uploading the comment to the server. Also disclosed is a mobile device for reviewing patient information according to the disclosed method.

### FIELD OF THE INVENTION

The invention relates to a method and a mobile device for reviewing patient information.

### BACKGROUND OF THE INVENTION

In a medical emergency, time is critical. A patient needs immediate medical attention in a hospital but clinicians who are experts in a field may not be available. Even if the clinicians are available, the clinicians may require time to travel to the hospital. Medical emergencies may also occur at a location where speedy transportation to a hospital is not possible. In such situations, the physical attendance of a clinician to the patient may not be possible.

Telemedicine may be used to bridge the physical distance between the patient and the clinician. An example may be the OsiriX Mobile viewer application which was reported in the article “Images in the Palm of Your Hand”, Radiology Today, Vol. 11 No. 1 P. 6, January 2010. Telemedicine frameworks of the prior art however may be application or media specific, be unreliable, be too bulky for the clinician, be user unfriendly for the clinician and/or be too slow for use in an emergency.

### SUMMARY OF THE INVENTION

The present invention aims to provide a new and useful method and mobile device for reviewing patient information.

In general terms, the invention proposes a mobile device retrieving patient information from a server using a resource identifier. The mobile device then displays at least part of the retrieved patient information on a screen of the mobile device. The displayed patient information is then reviewed to obtain a comment and the comment is uploaded to the server.

Specifically, a first expression of the invention is a method for reviewing at a mobile device patient information residing on a server, the method comprising the steps of
receiving a message from the server, the message having a resource identifier associated with the patient information;
retrieving the patient information from the server using the resource identifier;
displaying at least part of the retrieved patient information on a screen of the mobile device;
reviewing the displayed patient information to obtain a comment; and
uploading the comment to the server.

Preferably, the message is pushed from the server. Such a method may allow for the patient information comprising audio, video, images and text to be “pushed” to the mobile device. The use of the term “push” is understood to mean that the server has the onus of announcing the availability and facilitates the subsequent delivery of the patient information to the mobile device. In other words, a clinician using the mobile device may not need to poll the server for patient information. Preferably, the clinician cannot elect the patient information which is downloaded, but is capable of electing the part of the downloaded patient information which he reviews.

Preferably, the message is received over a first communications network and the patient information is retrieved over a second communications network, the second communications network being a different network from the first communications network. The first communications network may have a wider network coverage than the second communications network. Also, the second communications network may have a greater bandwidth than the first communications network.

Having a first communications networks with a bigger network coverage may permit the server to more reliably notify the mobile device about newly available patient information. The patient information may then be retrieved from the server using the second communications network which may have certain beneficial qualities e.g. a higher bandwidth or cheaper maintenance. Having a second communications network with a greater bandwidth than the second communications network may permit the mobile device to download patient information in real time.

For example, the first communications network may be a SMS network or an email network (in a broader sense, any broadcast network may be used, preferably capable of broadcasting a text message containing any Universal Resource Identifier (URI); using the URI, an associated program may be launched on the mobile device). The second communications network may be a Wi-Fi network, a GPRS network or an UMTS network. The SMS network or email network may have the advantages of being widely available and having a wider coverage. The SMS network or email network may also have the ability to “push” messages to the mobile device. The Wi-Fi network, GPRS network or UMTS network may have the advantage of having a high data bandwidth and thus may allow for the real-time download of patient information.

Preferably, the step of retrieving the patient information from the server comprises the step of sending a request to the server, the request including the resource identifier and an authentication code uniquely identifying the mobile device. This may have the advantage of combining the authentication and the request for patient information into a single request. The authentication code may comprise an IMEI number of the mobile device. Also, the authentication code may comprise a phone number or may comprise a Universally Unique Identifier (UUID) that is extracted from the mobile device.

Preferably, the resource identifier comprises a scheme indicator which identifies a program for retrieving the patient information, wherein a user of the mobile device can initiate the program using the scheme indicator, and the steps of retrieving the patient information and displaying at least part of the retrieved patient information are performed by the program. For example, the scheme indicator may be a prefix of the resource identifier.

Preferably, the method further comprises the step of editing the displayed patient information with the program.

The step of displaying at least part of the retrieved patient information may include displaying at least part of the retrieved medical information across multiple views.

The steps of retrieving the patient information and displaying at least part of the retrieved patient information may be repeated at regular intervals. This may permit the constant updating of patient information that is visible to the clinician.

The patient information may comprise a third-party comment that is uploaded to the server from a further mobile device, the third-party comment being based on patient information retrieved by the further mobile device. Clinicians who are experts in different fields may then exchange views on the kind of treatment to be administered.

The comment may be a region of interest marked on the displayed patient information, an audio recording and/or text. The comment is thus provided in a multimedia form which may enhance the quality of medical care in an emergency and may facilitates better treatment planning.

The method may further comprise the steps of
acquiring at another mobile device clinical information from a patient; and
uploading the acquired clinical information to the server to form at least part of the patient information. By using another mobile device to acquire and upload the clinical information to the server, the clinical information may be transmitted while on the move e.g. in the ambulance. This may thus speed up the availability of the clinical information.

For example, the patient information may be video, image, text and/or audio. By having patient information of such media types, better treatment planning may be possible at the hospital and this may reduce the reaction time to an emergency. This may also allow a clinician who is reviewing the displayed patient information to have a better understanding of the case at hand.

A second expression of the invention is a mobile device useable in a method according to the first expression of the invention, the mobile device comprising
a receiver configured to receive a message pushed from the server, the message having a resource identifier associated with the patient information;
a processor configured to retrieve the patient information from the server using the resource identifier;
a screen configured to display at least part of the retrieved patient information; and
a transmitter configured to upload a comment to the server, the comment being obtained from reviewing the displayed patient information.

A third expression of the invention is a method for sending patient information from a server to a mobile device, the method comprising the steps of at the server
generating a resource identifier which is associated with the patient information;
sending a message having the resource identifier to the mobile device; receiving from the mobile device a request comprising the resource identifier;
sending the patient information to the mobile device; and
receiving a comment from the mobile device, the comment being obtained from the sent patient information.

Preferably, the message is sent over a first communications network and the patient information is sent over a second communications network, the second communications network being a different network from the first communications network. The first communications network may have a wider network coverage than the second communications network. Also, the second communications network may have a greater bandwidth than the first communications network.

A fourth expression of the invention is a method for the parallel reviewing of patient information residing on a server, the method comprising the steps of
receiving at a plurality of mobile devices a message pushed from the server, the message having a resource identifier associated with the patient information; and
at each of the plurality of mobile devices
(i) retrieving the patient information from the server using the resource identifier;
(ii) displaying at least part of the retrieved patient information on a screen of each of the mobile devices;
(iii) reviewing the displayed patient information to obtain a comment; and
(iv) uploading the comment to the server.

Such a method for the parallel reviewing of patient information may encourage real-time interaction and collaboration between clinicians, and may create a live discussion forum. This may also facilitate the multi-way exchange of information between paramedics and clinicians specialized in different fields.

A fifth expression of the invention is a method for reviewing at a mobile device a medical image of a patient, the medical image residing on a server, the method comprising the steps of
retrieving the medical image from the server;
displaying at least part of the retrieved medical image on a screen of the mobile device;
reviewing the displayed medical image to obtain a comment; and
uploading the comment to the server.

A sixth expression of the invention is a method for reviewing at a mobile device patient information residing on a server, the method comprising the steps of
retrieving the patient information from the server;
displaying at least part of the retrieved patient information on a screen of the mobile device;
reviewing the displayed patient information to obtain an audio comment; and
uploading the audio comment to the server.

A seventh expression of the invention is a method for telemedicine comprising the steps of
acquiring at a first mobile device clinical information from a patient;
uploading the acquired clinical information to a server to form at least part of patient information resident on the server;
receiving at a second mobile device a message pushed from the server, the message having a resource identifier associated with the patient information;
retrieving the patient information from the server using the resource identifier;
displaying at least part of the retrieved patient information on a screen of the second mobile device;
reviewing the displayed patient information to obtain a comment; and
uploading the comment to the server.

Certain embodiments of the present invention may have the advantages of:
enhancing medical care during a clinical emergency;
assisting treatment planning during an emergency;
reducing the critical reaction time in an emergency;
allowing for the creation and maintenance of medical records for patients;
being flexible enough to handle medical emergencies involving any affliction e.g. a case involving a stroke or a case involving a cardiac arrest; and
utilizing multiple communications networks so that there is a redundancy in the communication.

### BRIEF DESCRIPTION OF THE FIGURES

By way of example only, one or more embodiments will be described with reference to the accompanying drawings, in which:

FIG. 1 is a schematic drawing of a telemedicine system 100 having multiple smart mobile phones and a central information server, according to an example embodiment;

FIG. 2 is a schematic drawing of the central information server of FIG. 1;

FIG. 3 is a schematic drawing of one of the smart mobile phones of the system of FIG. 1;

FIG. 4 shows a method for operating a program on one of the smart mobile phones of FIG. 1;

FIG. 5 is a screenshot of an “info.plist” file of the program of FIG. 4 when opened in an editor;

FIG. 6 is a schematic drawing of the interaction between one of the smart mobile phones and the central information server of FIG. 1;

FIG. 7 is a schematic drawing of the browsing sequence for multiple views of the program of FIG. 4;

FIG. 8a is a screenshot of an EMR Table-View of the program of FIG. 4;

FIG. 8b is a screenshot of a Text-View of the program of FIG. 4;

FIG. 8c is a screenshot of an Image-View of the program of FIG. 4;

FIG. 8d is a screenshot of an Audio-Video View 640 of the program of FIG. 4;

FIG. 8e is a screenshot of a video file being played in the Audio-Video View of FIG. 8d;

FIG. 9 is a screenshot of the program of FIG. 4 as uploading is underway; and

FIG. 10 shows a method conducting telemedicine using the system of FIG. 1.

### DETAILED DESCRIPTION OF THE PREFERRED EMBODIMENT

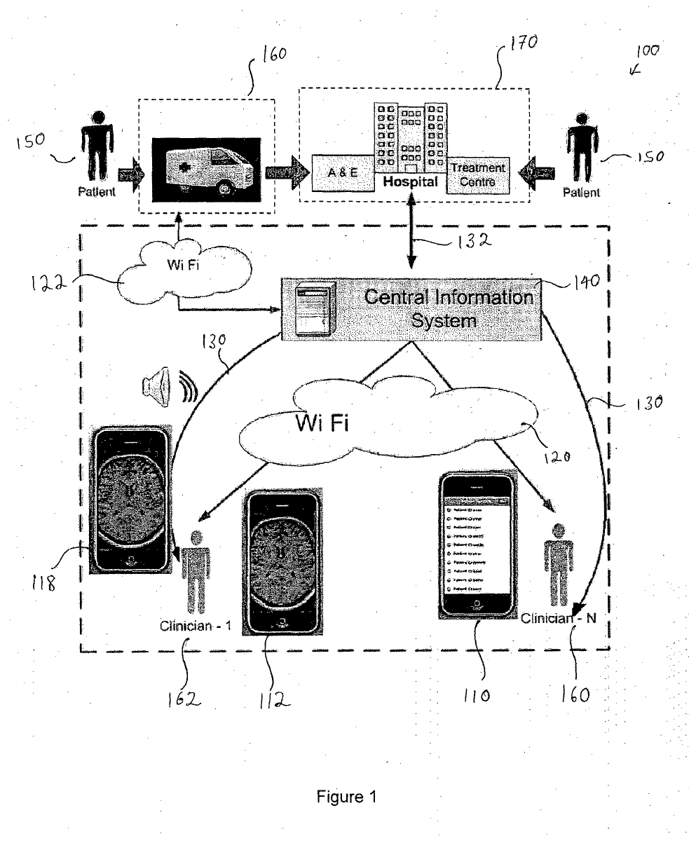

FIG. 1 shows a telemedicine system 100 according to an example embodiment. The system 100 comprises a central information server (CIS) 140, an ambulance-based information acquisition device 160, a hospital-based information acquisition device 170 and a first 110, second 112 and third 118 smart mobile phones. The information acquisition devices 160, 170 acquire clinical information about patients 150. The ambulance-based information acquisition device 160 may for example be another smart mobile phone, a digital camera, a mobile X-ray unit or a mobile computer. The hospital-based information acquisition device 170 may for example be a personal computer, a tomographic device such as a CT or MRI scanner, or yet another smart mobile phone.

The ambulance-based information acquisition device 160 is capable of communicating with the CIS 140 over a first Wi-Fi network 122 and the hospital-based information acquisition device 170 is capable of communicating with the CIS 140 over a wired network 132. The information acquisition devices 160, 170 thus uploads the acquired clinical information over the respective networks 122, 132 to the CIS 140.

The first 110, second 112 and third 118 smart mobile phones may for example be iPhones or Android mobile phones and are each capable of communicating with the CIS 140 over a second Wi-Fi network 120. The smart mobile phones 110, 112 and 118 are each also capable of receiving messages e.g. Short Message Service (SMS) or Multimedia Message Service (MMS) messages over a mobile telephony network 130. The clinical information is stored in the CIS 140 alongside any existing information about the patient to collectively form patient information. When clinical information is uploaded into the CIS 140, a first clinician 160 receives a message over the mobile telephony network 130 on the first smart mobile phone 110. This message contains a resource identifier associated with the patient information which permits the first smart mobile phone 110 to retrieve the patient information over the second Wi-Fi network 120. The first clinician 160 thus may perform a review of the patient information and upload his comments onto the CIS 140 using the second Wi-Fi network 120.

Optionally, a second clinician 162 may also receive the same message over the mobile telephony network 130 on the second smart mobile phone 112. Similar to that for the first smart mobile phone 110, the second mobile phone 112 may use the resource identifier in the message to retrieve the patient information over the Wi-Fi network 120. The second clinician 162 thus may perform a parallel review of the patient information. It is also noted that the patient information retrieved by the second mobile phone 112 may contain the comments uploaded to the CIS 140 by the first clinician 160.

The Central Information Server (CIS) 140

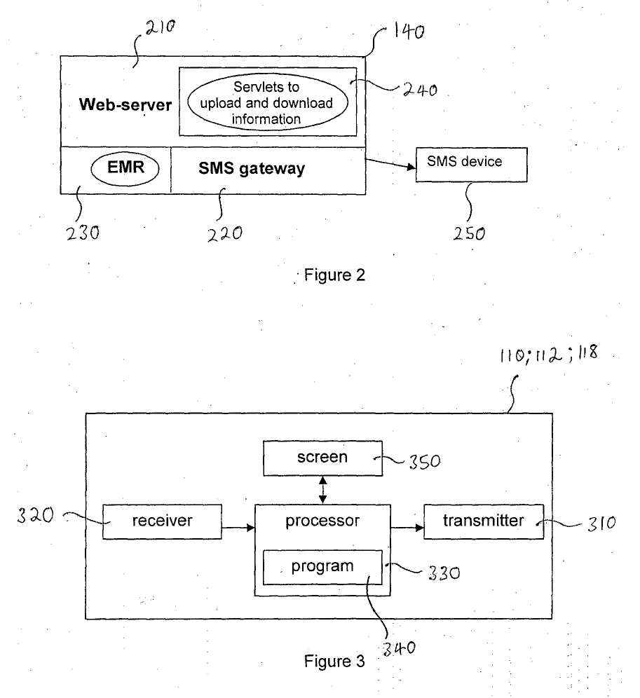

The CIS 140 and its components will be described next with the aid of FIG. 2. FIG. 2 is a schematic drawing of the CIS 140 of FIG. 1. The CIS 140 is a server machine running Linux as the operating systems. The programs operating within the CIS 140 comprises a web-server 210 running a servlet container 240, an SMS gateway 220 which permits the pushing or broadcast of SMS messages to multiple smart mobile phones and a database 230 which holds the patient information along with any associated electronic medical records (EMR).

The Linux operating system is used in the CIS 140 because it may provide a UNIX-like environment upon which the web-server 210 and the servlet container 240 runs more efficiently. Further, Linux may offer better web-server 210 security. The Linux operating system is generally available free and in an open source format, and may come with built in support for the Apache web-server 210 software, as well as the Tomcat servlet container 240.

The Web-Server 210 and the Servlet Container 240

An open-source web-server software such as Apache 2.x is used for the web-server 210. Further, a servlet container 240 such as Tomcat 6.x runs within the web-server 210. Together, the web-server 210 with the servlet container 240 function as a secure portal which may help to protect patient information that is uploaded or download.

The servlet container 240 in turn supports the running of Java servlets. The servlets running in the container 240 act as conduits through which patient information is uploaded or downloaded. As is shown in FIG. 2, the container 240 has logical access to the first 120 and second 122 Wi-Fi networks, as well as the wired network 132.

The Apache web-server 210 is first installed in the server machine. This is done either doing a manual install of the Apache web-server 210 by compiling the native source code or an automated installation in the form of executing “.rpm” (Redhat Package Manager) files.

After installing the Apache web-server, the web-server 210 is configured to handle secure requests. Under normal circumstances the web-server runs on the “http” port, i.e. the network port “80”. In order to enable secure communications, communication on the “https” port are enabled, i.e. the network port “443”. All communications made via the “https” port may be encrypted and secure. In order to confirm that the web-server 210 is properly installed, when the CIS 140 is accessed through a web request, for example http://www.abc.xyz, an HTML page will be displayed indicating correct installation. This would mean that the Apache web-server is up and running.

The Tomcat servlets container 240 is then installed. This is done either by doing a manual install from compiling the native source code, or by using an automated “.rpm” package. Once installed, Tomcat is started by navigating to the “bin” directory under the Tomcat installation directory and issuing the command “/startup.sh”.

Tomcat uses the Java Development Kit (JDK) and the Java Run-time Environment (JRE). The JDK and JRE are thus installed and the correct path to the JDK is specified to Tomcat. Tomcat runs on the port 8080 but requests made to the web-server 210 are directed to port 80. Thus, in order to redirect these requests to servlet container 240 i.e. in other words to make Tomcat “run” on port 80, “connectors” are used. A possible connector is a program by the name of mod_jk. mod_jk is installed and the configuration files of Apache and Tomcat are modified in order to enable communication between the web-server 210 and the servlet container 240 via the “connector”. This communication between the programs is carried out using “worker” threads. A file by the name of “worker.properties” is created together with the configuration files of Apache. The configuration files of Tomcat may be found in the “conf” directory under the Tomcat installation directory. The Tomcat configuration files and the “worker.properties” file are modified to listen on port 80.

With the Apache web-server 210 and the Tomcat servlet container 240 properly configured, servlet files are added into the servlet container 240. Servlets files are Java programs which are dedicated to handling HTTP or HTTPS web-requests. A servlet file typically utilizes two programming functions namely:
1.) doGet(HttpServletRequest request, HttpServletResponse response and
2.) doPost(HttpServletRequest request, HttpServletResponse response).

A HttpServletRequest object is a request that is made from a client (i.e. for example a program running on the smart mobile phone 110, 112 or 118) to the CIS 140. When making such a request, the client supplies all the information which the server requires. A HttpServletResponse object is the response from the CIS 140 to the request from the client. doGet and doPost respectively refer to the GET and POST methods of submitting a request to the CIS 140. In a GET request, the parameters are appended within the Universal Resource Locator (URL) used to perform the request. An example of a URL for a GET request is “http://www.abc.xvz/?name=abc&password=def”. When the number of parameters increase however, the POST method may be used. In the POST method, the parameters for the request are not explicitly specified within the URL, but are included as parameters in the request header. The web-server 210 is capable of handling requests received at the CIS 140 across the Internet or over a private network.

The servlets may take the form of about 2 servlet classes. The servlets are programmed to allow a medical professional attending to a patient to:
log in to the CIS 140;
upload clinical information to the CIS 140;
select one or more clinician to direct the patient information to;
automatically send a SMS message to the selected one or more clinician;
display the result of uploading the clinical information and sending of the SMS message;
display the patient information after it is edited by a third-party; and
display comments on the patient information after the comments are uploaded by a third-party.

The servlets interact with the database 230 in order to authenticate the doctor logging in to the CIS 140. The authentication details (e,g, usernames and passwords) are stored in the database 230. The medical professional when logging in specifies his username and password. The username and password are encrypted when they are sent to the CIS 140 because HTTPS is used. They are decrypted when they arrive at the servlet and are verified against the usernames and passwords stored in the database. Upon a successful login, the medical professional is shown a home page which allows the options of:
selecting clinical information to upload;
selecting one or more clinicians to contact; and
proceeding to upload the clinical information and send a SMS message to each of the selected one or more clinicians.

The SMS Gateway 220

It is seen in FIG. 2 that the SMS gateway 220 forms part of the CIS 140. The SMS gateway 220 is linked to an SMS device 250 which is capable of transmitting SMS messages over a mobile telephony network 130. The SMS device 250 may for example be a GSM modem or a mobile phone. The SMS gateway 220 permits the automatic pushing of SMS messages from the CIS 140 to the one or more clinicians. This may be done simultaneously, in order to initiate a parallel review of the patient information by clinicians from different disciplines.

The KANNEL SMS gateway software used in the present embodiment is of the version 1.4. The use of KANNEL may have the advantage of having an open-source SMS gateway 220 that is easy to install and configure, while also being highly compatible with LINUX.

KANNEL is installed on the CIS 140 server machine by running the installation. The configuration file for the KANNEL gateway is then edited. The primary parameters edited include:
the port number on which the SMS gateway runs;
the configuration for secure connections i.e. configuration for HTTPS;
an option for storing the SMS messages in a database;
the method of connecting the SMS device 250 to the CIS 140; and
a username and password for the connection.

The SMS device 250 may be a GSM modem or a mobile phone. In the former case, the GSM modem is a dedicated modem with a SIM card inserted, thus allowing it to send SMS messages.

Alternatively, in the latter case where a mobile phone is used, the mobile phone has a SIM card inserted in it which allows it to send SMS messages. The mobile phone may be connected to the CIS 140 using a Universal Serial Bus (USB) port or COM ports. In this case, the use of the mobile phone creates a “virtual SMS center”—“virtual” because the SMS center of the mobile service provider who issues the SIM card serves as the actual SMS center from which SMS messages are sent.

In the present embodiment, a Nokia E51 mobile phone is used as the SMS device 250 and a SingTel SIM card is inserted into the mobile phone. The Nokia E51 is connected to the CIS 140 server machine using a USB port. Once connected, the SMS gateway 220 program is started by issuing the commands:
/bearerbox configfilename; and
/smsbox configfilename.

Once the SMS gateway 220 program is started, the startup logs are checked to see if the program is able to recognize and communicate with the connected SMS device 250.

The sending of a SMS message is done by issuing a HTTP request from the Java servlet that is running in the servlet container 240, to the SMS gateway 220. As an example, a HTTP request of the form “http://localhost:13013/cgi-bin/sendsms?username=xxx&password=yyy&to =123456&text=hello” is issued to the SMS gateway 220 by the servlet. The HTTP request contains authentication fields in the form of “username=xxx” and “password=yyy”. The phone number to push the SMS to is in the field “to =123456” and the message to be sent is contained in the field “text=hello”.

The SMS gateway 220 parses HTTP requests received from the servlet. By parsing the HTTP request, the SMS gateway 220 obtains the phone numbers to which the SMS is to be pushed to and the message that is to be pushed. The SMS gateway 220 then sends the SMS. After the SMS message is sent, the medical professional is then automatically guided to the next HTML page which displays the outcome of the uploading of clinical information, as well as the results of the SMS transmission.

The Database 230

The CIS 140 of FIG. 2 also comprises a database 230 for storing patient information, login details for authentication purposes, as well as contact and specialization information relating to the clinicians. The patient information stored may be multimedia and multimodal in nature, i.e. it may comprise audio, video, text and/or image information, and may comprise such information as the EMR of patients and/or prescription record of patients. The patient information may be large and the use of a database 230 may allow for a more efficient access to the patient information. The use of a database program may also add a level of data security.

mySQL is used as the program for running the database 230 and is installed with the basic or default configuration. mySQL is an open-source database program. The relevant data tables are then created manually in the database using a web-admin interface.

In the present embodiment, the components of the CIS 140 i.e. the web-server 210, the servlet container 240, the SMS gateway 220 and the database 230 all run on a single Linux platform. It is however envisaged that the components may be implemented in a distributed fashion across multiple servers. The multiple servers in turn may also be resident in different computer networks, but still being interconnected to each other.

Further, while the HTTP protocol is used to make requests to the web-server 210 and SMS gateway 220, it is envisaged that the requests could use any other protocol, e.g. HTTPS. The web-server 210 is implemented in the present embodiment using Apache 2.x. Other web-server programs could instead be used, e.g. Microsoft IIS Also, the database 230 in alternative embodiments may also be implemented using other database programs such as Oracle.

The Smart Mobile Phones 110, 112 and 118

FIG. 3 is a schematic drawing of a smart mobile phone 110, 112 or 118 of the system 100. The smart mobile phone 110, 112 or 118 is capable of displaying multimedia information such as images, audio, video and text. The smart mobile phone 110, 112 or 118 is also capable of data access over one or more data networks, e.g. through WI-FI, through 2.5G mobile technologies such as General packet radio service (GPRS) or through 3G mobile technologies such as Universal Mobile Telecommunications System (UMTS). In other words, data access to the Internet may be made using Wi-Fi or 2.5G/3G mobile networks. This may permit a redundancy in the availability of data access thus in a specific example, should mobile broad-band coverage be unavailable, GPRS may be used instead.

It is noted that the smart mobile phone 110, 112 or 118 may be connection agnostic in that the functionality of the smart mobile phone 110, 112 or 118 does not depend on the data network used. Taking the example where Wi-Fi is first used as the data access network, where there is no Wi-Fi access available or where the bandwidth available on a Wi-Fi network is low, the smart mobile phone 110, 112 or 118 may switch onto a 2.5G or 3G network.

By using a smart mobile phone 110, 112 or 118, the high processing power of the device may be combined with the unique functionalities of a mobile telephony device and thus may permit the convergence of other-wise exclusive technologies.

This is done across a transmitter 310 of the smart mobile phone 110, 112 or 118 which allows such functionality as the uploading of information to the CIS 140. Since the smart mobile phone 110, 112 or 118 is capable of data access over more than one network, this may have the advantage of improving connectivity and availability of the Internet, even while the smart mobile phone 110, 112 or 118 is on the move.

The smart mobile phone 110, 112 or 118 comprise a receiver 320 capable of receiving SMS messages pushed from the CIS 140. Contained within the SMS message would be a Universal Resource Identifier (URI) which is associated with the patient information that is on the CIS 140.

The smart mobile phone 110, 112 or 118 also comprises a processor 330 that is capable of launching a program 340 using the URI. The URI will contain a scheme indicator which identifies the program 340 for handling the URI. In other words, by clicking on a “link” containing the scheme indicator, the user of the smart mobile phone 110, 112 or 118 is able to launch an associated program 340. The program 340 running on the processor 330 is then able to retrieve the patient information from the CIS 140 using the URI.

The smart mobile phone 110, 112 or 118 further comprises a screen 350 which also functions as a means for a user to interact with it. This takes the form of a touch screen that may be operated using a finger or fingers, or a stylus. The screen is configured to display at least part of the patient information retrieved from the CIS 140. The smart mobile phone 110, 112 or 118 contains sufficient memory and graphics processing power to allow the loading and manipulation of images. When manipulating an image, the user may use the touch screen to draw Regions of Interests (ROI), zoom-in and out, or pan.

The iPhone is used as the hardware for the smart mobile phones 110, 112 and 118. The iPhone has a programmable API which is publicly available. The API may allow for the rapid development of applications by developers. The use of the iPhone may also have the advantage of having smart mobile phones 110, 112 and 118 which are of high power, of a portable form-factor, and which have a high resolution display allowing for high quality graphics.

Program 340

A program 340 is developed for operation on the smart mobile phones 110, 112 and 118. This program 340 is capable of retrieving patient information from the CIS 140, displaying the retrieved patient information and allowing a user to review the patient information and offer a comment.

The program 340 is developed using the iPhone Software Development Kit (SDK) provided by Apple. This is done using the Integrated Development Environment (IDE) known as XCode. The SDK provides an Application Programming Interface (API) which facilitates the development of applications for the iPhone. The Objective-C and C programming languages are used.

The iPhone SDK comprises the Cocoa Touch API. The Cocoa Touch API is an extension of Cocoa allows the development of programs that run on iPhones and iPods. The Cocoa Touch classes include Controllers e.g. View Controller and Navigation Controller, Data Views e.g. Table View and Image View, Inputs and Values e.g. buttons, text-fields and sliders, Windows Views, and Bars e.g. Search Bar and navigation Bar. The API is used to implement the core features of the program 340 such as application management, graphics and windowing support, event-handling, user interface management, views and controls, and support for text and web content. The API also allows the retrieval of accelerometer data, camera images and device-specific information e.g. the IMEI.

The iPhone SDK further comprises a core graphics frame-work named Quartz. Quartz allows the development of interactive Graphical User Interface (GUI), based programs and includes a 2D renderer, as well as a composition engine that sends instructions to the graphics card. This frame-work provides the functionalities to for displaying, editing and manipulating image data.

The iPhone SDK also comprises other frame-works such as Open-AL for the playing of audio, Movie Player that allows for the playing of audio and video, and Interface Builder which is an IDE allowing for the rapid design and development of the GUI using the Cocoa Touch API.

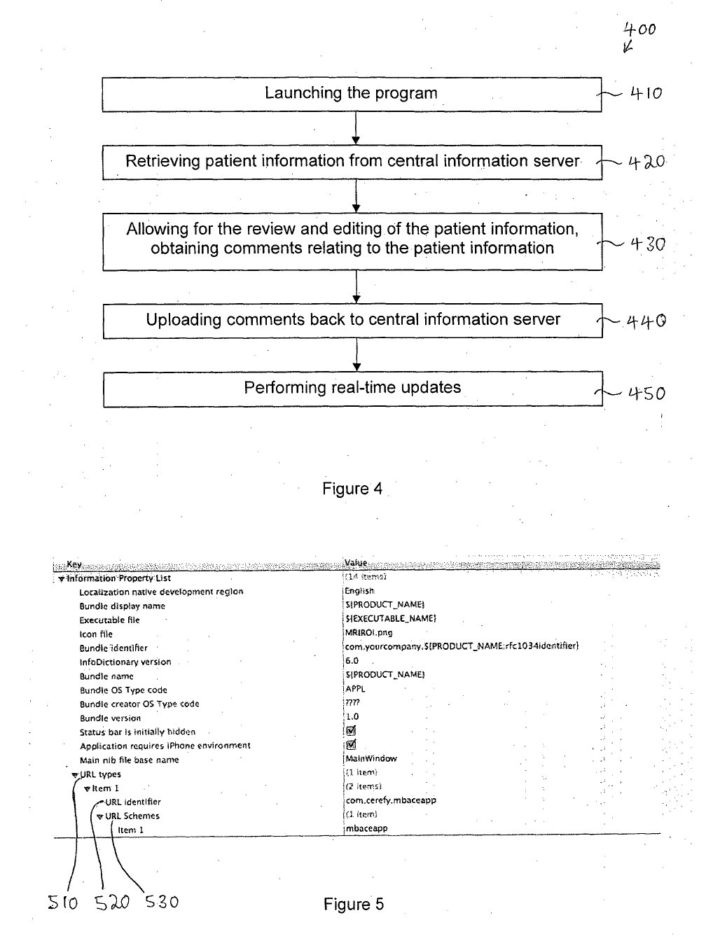

The program 340 developed for use in the smart mobile phones of the system 100 of FIG. 1 will now be described next with the aid of FIGS. 4 to 7. Referring first to FIG. 4, FIG. 4 shows a method 400 for operating the program 340.

In step 410, the program 340 is launched. The program 340 has an associated “info.plist” file. The “plist” file extension stands for property list. The property list file essentially is an eXtendable Mark-up Language (XML) file which stores information such as the icon image that is to be associated with the program 340, the program name and the display of the status bar.

Reference is made to FIG. 5 which shows the “info.plist” file of the program 340 when opened in an editor. The file comprises a property field by the name of “URL types” 510. A “URL type” 510 consists of two components i.e. a “URL Identifier” 520 and “URL Schemes” 530. The “URL Identifier” 520 is set to be “com.cerefy.mbaceapp” and “URL Schemes” 530, which denotes the scheme indicator, is set to be “mbaceapp”. This allows the program 340 to be launched when a URI with the scheme indicator prefix of “mbaceapp: //” is clicked.

In step 420, the program 340 retrieves patient information from the CIS 140. This is done by connecting to the CIS 140 to authenticate itself and then downloading the patient information specified in the URI.

The program 340 has associated with it an “AppDelegate” class which is derived from an “UIApplicationDelegate” class. The latter class is standard in the iPhone SDK while the purpose of the former class is to control of the behavior of the program 340 once it is launched.

Taking the example where the URI of “mbaceapp://192.168.1.100/axial” is clicked and the program 340 is launched, in order to parse the URI, a UIApplicationDelegate method with the name of “handleOpenURL” is implemented. A prototype of the “handleOpenURL” method follows.

```
(BOOL) application: (UIApplication*) application handleOpenURL:
(NSURL *) url {
    [self processURL:url];
    return YES;
  }.
```

The “handleOpenURL” allows the program 340 to receive the URI and parse for information present in the URI. This happens in a way which is transparent to the user. The program 340 automatically parses the URI for a server name and a dataset. Taking the URI of “mbaceapp://192.168.1.100/axial” as an example, the server name is “192.168.1.100” and the dataset is “axial”. The following pseudo code shows how the URI is parsed.

```
(void) processURL: (NSURL *)url{
  //NSURL is the input URL
  //Convert the URL in to the form of a String Object.
  NSString * sms = [url absoluteString];
  //Now we split the message in to strings separated by “/”, i.e. we split
  //192.168.1.100/axial in to 192.168.1.100 and axial.
  NSArray *messageArray = [sms componentsSeperatedByString:@”/”];
  NSString *Ipaddress = [[NSString alloc] initWithFormat:@”%@”,
  [messageArray ObjectAtIndex:0]];
  NSString *dataSetName = [NSString alloc] initWithFormat:@”%@”,
  [messageArray ObjectAtIndex:1]];
}
```

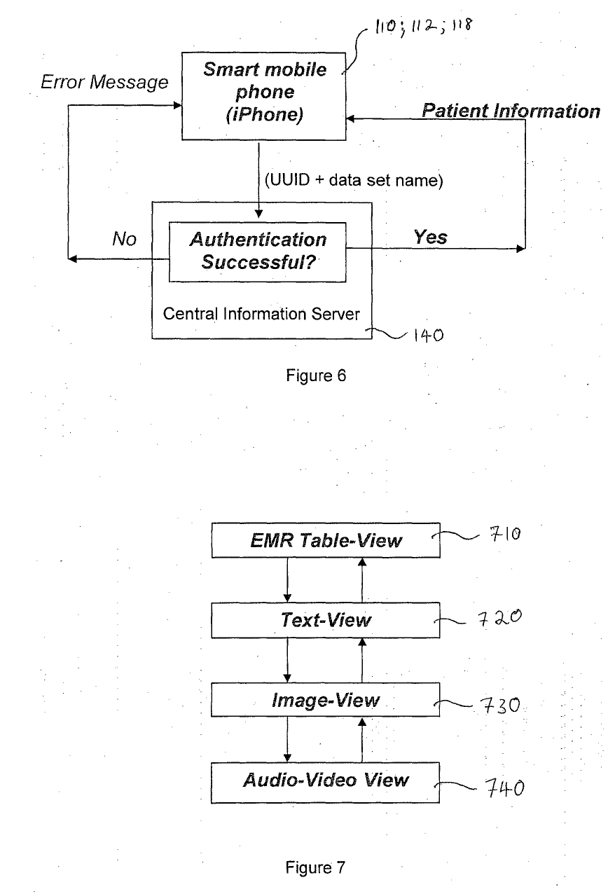

Turning to FIG. 6, FIG. 6 is a schematic drawing showing the interaction between the smart mobile phone 110, 112 or 118 and the CIS 140. The program 340 on the smart mobile phone 110, 112 or 118 connects to the CIS 140 by authenticating and making a request for the patient information using the dataset identifier. The authentication code and the request for the patient information is transmitted in a POST or GET format as a single HTTP request. Optionally, the request may be made using a HTTPS request or a request based on sockets.

If the authentication code is valid, the patient information is sent from the CIS 140 to the smart mobile phone 110, 112 or 118. Otherwise, an error message is returned. An example of such a HTTP request using the GET format follows. http://www.xyz.cbma/?UUID=hasdftyag342347q346&datasetname=vbcn

The authentication code uniquely identifies the smart mobile phone and may comprise the IMEI number. The authentication code may also be a Universally Unique Identifier (UUID) in the iPhone. The following command is used in the program 340 to extract the UUID from the iPhone.
NSString *id=[[UIDevice currentDevice] uniqueIdentifier];

Optionally, the authentication code may further comprise the phone number of the smart mobile phone. This may introduce an added level of security. Since the authentication code is unique to the smart mobile phone, this may be used to identify the clinician that is retrieving patient information from the CIS 140. The authentication codes of all clinicians using the system 100 may be stored in a table of the database 230 of the CIS 140, thus mapping the authentication code of each clinician with his smart mobile phone.

After a successful authentication, the CIS 140 then sends the patient information to the smart mobile phone and the program 340 downloads the patient information into the smart mobile. The patient information is multimedia and may be a combination of text, images, audio and video. In the case where the request is made as part of an information refresh or where other clinicians have uploaded their comments to the CIS 140, the patient information may automatically further comprise the comments and feedback from these clinicians.

Returning now to FIG. 4, in step 430, the program 340 allows for the review and editing of the patient information, and further also obtains comments relating to the patient information. The program 340 is developed using the “Model View Controller” (MVC) paradigm, where “model” refers to the data model, “view” refers to what is seen on the screen and “controller” is what controls the “view”. Such “controllers” for example include responds to events such as button clicks and taps on the screen. A data “model” may have multiple “views” of it. Taking tomographic images contained within the patient information as an example, a data “model” comprising a volume of medical images may be viewed along the axial, coronal and sagittal orientations.

Reference is made to FIG. 7 which shows the views present in the program 340 and the browsing sequence for the views. When the patient information is downloaded by the program 340 from the CIS 140, the program 340 allows review of the views in the order shown.

The first view that is displayed is the EMR Table-View 710 which includes those comments made by other clinicians. The Text-View 720 is then displayed next which shows the text information within the patient information. Next, the Image-View 730 is displayed showing the images included in the patient information. Finally, the Audio-Video View 740 is displayed showing a table with details of the audio-video files associated with the patient information.

The clinician who is using the program 340 on his smart mobile device is allowed to navigate the views sequentially back and forth. In other words, if for example the clinician intends to go to the Image-View 730 from the EMR Table-View 710, he first has to navigate to the Text-View 720, then navigate from the Text-View 720 to go to the Image-View 730. The views 710 to 740 will be described in detail later in this specification.

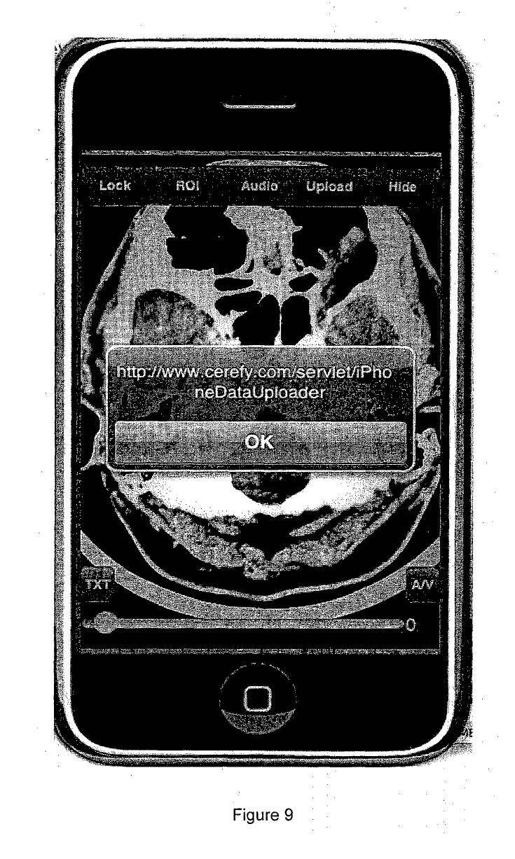

Returning back to FIG. 4, in step 440 the comments made by the clinician when reviewing the patient information displayed in the views 710 to 740 are uploaded back to the CIS 140. The comments that are uploaded comprise the edited patient information and observations made by the clinician. The upload is performed by switching to the Image-View 730 and clicking on the upload button 7306. The program 340 then automatically connects to the CIS 140, authenticated itself and then uploads the comments. As the upload is underway, the program 340 displays on its screen a view as shown in FIG. 9. FIG. 9 shows the screen of the smart mobile phone as uploading is underway.

At the CIS 140, the comments that are uploaded from the smart mobile phone 110, 112 or 118 are saved under a folder named with the UUID of the smart mobile phone 110, 112 or 118. This folder is created under a main folder of the database 230 which contains the original patient information. If the folder does not exist, for example where this is the first time a clinician is making a comment on the patient information, the folder is created.

In step 450, real-time updates are performed to reflect the up-to-date patient information in the program 340. The real-time updates are provided in the EMR Table-View 710 and the EMR Table-View 710 is automatically updated every 30 seconds. Such real-time updates show any new comments contributed by a third-party clinician that may be available on the CIS 140. These third-party comments are referred to as “sub-cases”. The updating mechanism enables a parallel review of the patient information as each clinician with access to the patient information is free to view the comments made by another clinician. Such a parallel review may permit a moderation of the observations of each clinician and may permit collaboration.

The automatic real-time update functionality is implemented in the EMR Table-View 710 by animating the view in the iPhone SDK. This allows the repetition of actions after a specified time interval. In the present embodiment, the time interval is specified to be 30 seconds. At the end of each time interval, the program 340 connects to the server and checks on the availability of new sub-cases or any other updated patient information. The program 340 then updates the local information accordingly. The views 710 to 740 then display the updated local information.

The views 710 to 740 are described next with the aid of FIGS. 7a to 7e. These views 710 to 740 are implemented using the MVC paradigm which allows the program 340 to have multiple views. Multiple views allow a multi-media display of the patient information—the Text-View 720 displays text information, the Image-View 730 displays image information, while the Audio-Video View 740 displays audio and video information.

EMR Table-View 710

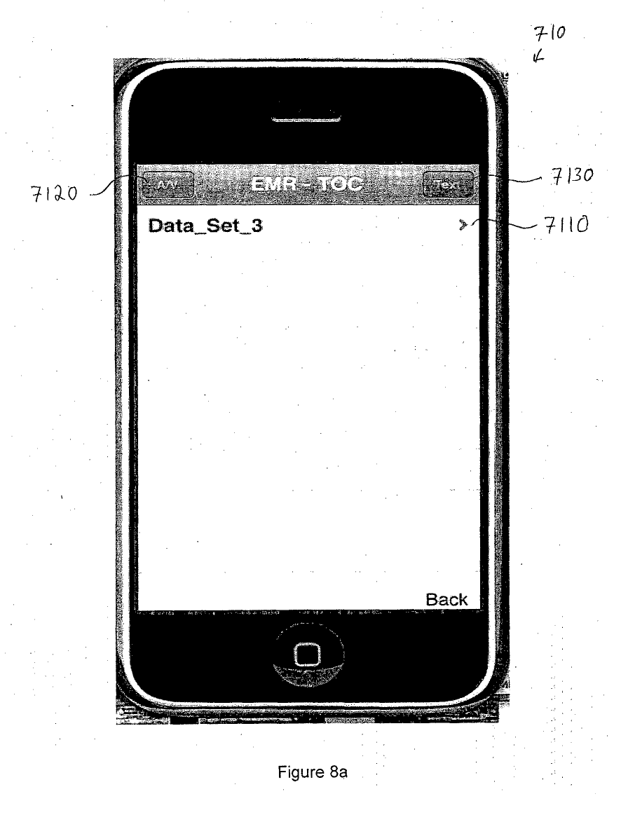

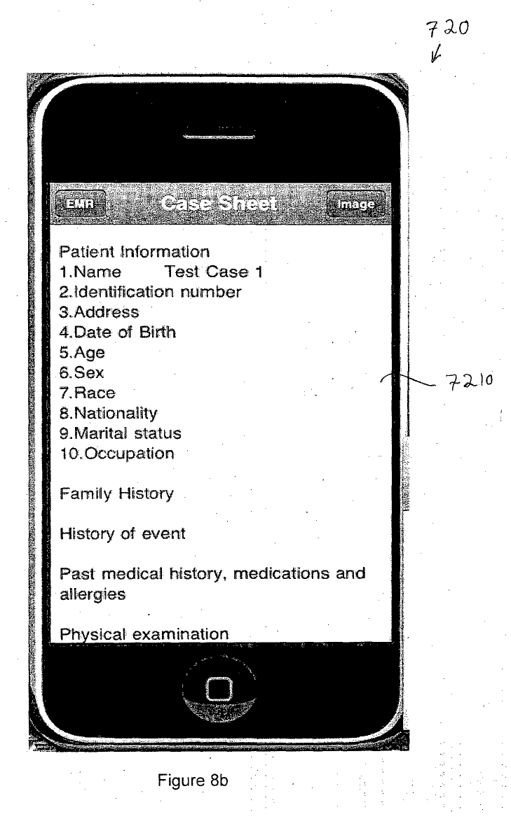

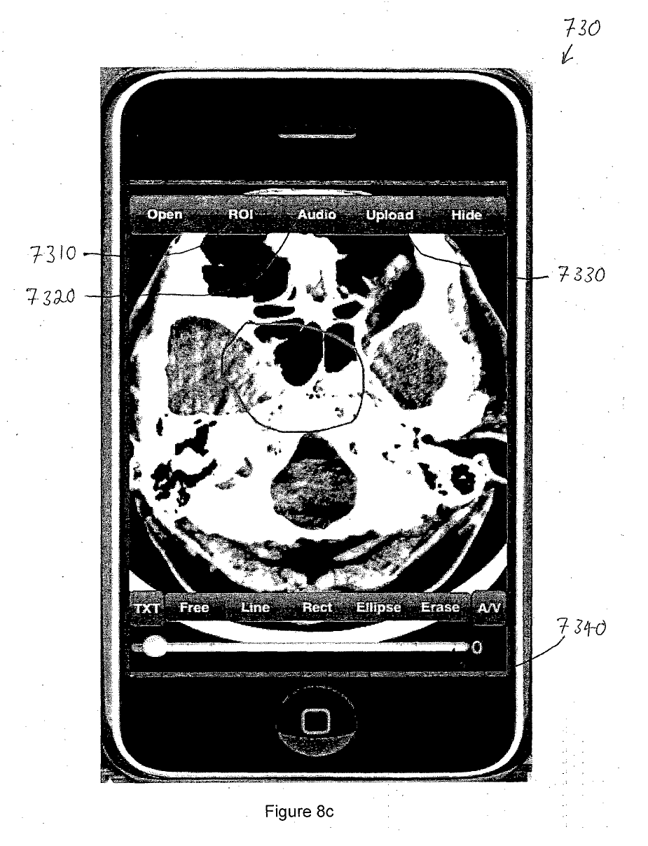

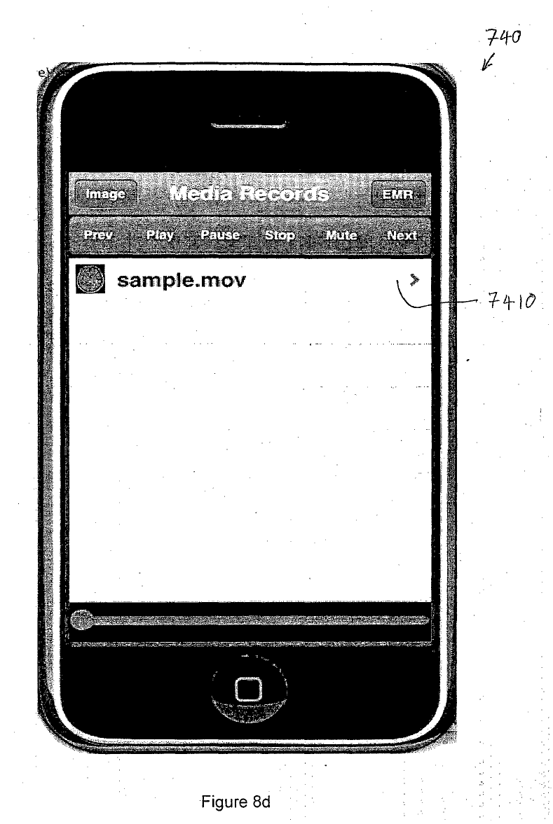

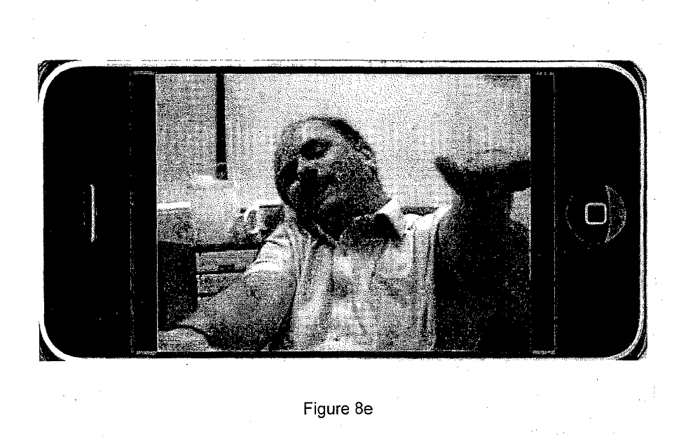

Reference is now made to FIG. 8a which shows the EMR Table-View 710 of the program 340. The EMR Table-View 710 comprises a table 7110 which contains a list of patient cases which the clinician is responsible for, as well as patient sub-cases where the clinician is able to provide a third-party comment. The clinician may choose which case or sub-case he wants to view. The EMR Table-View 710 communicates with the CIS 140 and automatically updates or refreshes every 30 seconds in order to retrieve up-to-date patient information containing the comments provided by other clinicians. Once the clinician has chosen the case that he wants to view, the next page, i.e. the Text-View 720 is displayed. The clinician may also use the button 7120 or button 7130 to respectively navigate to the Audio-Video View 740 or the Text-View 720.

Using the MVC paradigm, the EMR Table-View 710 is implemented using the Cocoa Touch UITableViewController class which acts as the controller class, and the UITableView class, which acts as the view class. The model associated with the view and controller classes is the NSMutableArray object. The NSMutableArray object is an array that grows in size when objects are added and the objects in the array may be changed.

The EMR Table-View 710 is made to update itself once every 30 seconds. This is done using the StartAnimation function which is provided by the iPhone SDK. The StartAnimation function animates the view so that the view updates every 30 seconds. By doing so, the model associated with the view is updated with information retrieved from the CIS 140. The view then displays the updated model.

Text-View 720

FIG. 8b shows the Text-View 720 of the program 340. This view is displayed when the clinician chooses a case or sub-case from the table of the EMR Table-View 710. The view displays text information 7210 that is within the patient information downloaded. This text information may comprise details about the patient such as the name, age, height or weight. The text information 7210 may further comprise vital parameters such as the blood pressure, pulse rate and/or any other data of clinical relevance. Further, the clinician may be allowed to edit the text information 7210 by for example uploading a text file containing modified information. The clinician may also provide comments about the patient information in the form of text.

The Text-View 720 is implemented using the UITextViewController class as the controller. Associated with the controller class is the UITextView view class. This class controls the display of information to the user. Further, the controller class also has an object of type NSString. This object represents the model and stores the text that is to be displayed in the text view.

Image-View 730

Turning now to FIG. 8c, FIG. 8c shows the Image-View 730 of the program 340. This view displays the images contained within the patient information. The images may for example be CT, MRI (of multiple modalities, T1, T2), DWI, and DTI images. Further, the image may also be an ECG or an EEG signal chart. Using the case of a set of tomographic images as an example, this view provides the clinician with the option of scrolling through the individual slices that make up the volume using a slice selector 7340. The clinician may then scroll, pan or zoom through the images for better viewing. The clinician may then edit or provide comments about the images by drawing Regions of Interests (ROIs) on the images. This is done by selecting the ROI button 7310 and then drawing the ROI. The ROIs may for example be a region where a stroke infarct is present, or a region where a hemorrhage is present. The view provides options for the clinician to draw ROIs free Hand, or in the form of lines, or ROIs shaped as a rectangle or an ellipse. The ROIs drawn may be erased. Further, the view provides an option for the clinician to record his comments in the form of an audio. These audio files are stored in the smart hand phone and the uploaded to the CIS 140.

The Image-View 730 is implemented using the UIViewController controller class and a UIScrollView view class. The UIScrollView class in turn override the UIView class. The usage of the UIScrollView class may enable the smooth panning and zooming of images. While the UIScrollView class controls the scrolling, panning and zooming functionality, the ability to draw ROIs is conferred by overriding the UIView class. The UIView class has for example a drawRect function which is used for the drawing of a rectangular. ROI. The Quartz2D API is then used to display images within the view, as well as to draw the various ROIs.

The Image-View 730 displays an image by first reading the image directly from the downloaded file using the command:
UIImage *image=[UI Image imageWithContentsOfFile:filename];

Then, the read image is converted to a CGImage using the command:
CGImage displayImage=[image CGImage];

The CGImage is a Core Graphics object. The current graphics context is then obtained using the command:
CGContextRef context=UIGraphicsGetCurrentContext( );

The screen area over which the image is displayed is then determined. This area is a rectangle and may be set manually or derived from the frame of the view. The image is displayed in the area using the command:
CGContextDrawImage(context,bounds,displayImage);

Alternatively, the image may be displayed using the command:
[displayImage drawInRect:bounds];

The image formats that are supported for display are formats such as TIFF, JPG and PNG which are supported by the device. Formats which are not natively supported on the iPhone, e.g. the RAW format, may still be displayed using a conversion or custom interpretation process.

A clinician using the program 340 is allowed to mark ROIs on the image. This is done by drawing the ROIs on the context, but not on the image. By not drawing on the image, the image data is not modified. The ROI is drawn by the clinician dragging or sliding a finger on the display of the iPhone. The points of impact of the finger on the screen are collected as the clinician drags his finger along the screen. These points which are collected are then used to draw ROIs of different shapes on the context. The collection and drawing of ROIs is done using the following pseudo-code.

```
Declare MutablePathRef PointsArray;
If ( fingerDragging ){
    Point pt = getcurrentpoint( );
    PointsArray.addPoint( pt );
}
If ( fingerReleased ){
PointsArray.closePath( );
PointsArray.drawOnContext(currentGraphicsContext);
}
```

The thickness and colour of the ROI curve may be set. The ROI may also be erased by deleting all the collected points.

Further, the Image-View 730 has an audio recorder. The audio recorder allows the clinician to record audio comments about the patient information. The clinician starts the audio recorder by selecting the button 7320. This is implemented using the standard AudioToolBox frame-work available in the iPhone SDK. A queue data structure with a First In First Out property is created and the digitized audio is read in chunks directly from the microphone. Then the chunks are then added to the queue. As the recording progresses, the audio chunks at the head of the queue are progressively de-queued and written to a file. The sampling rate of the audio i.e. the number of audio samples per second may be set. The resolution of each audio sample i.e. 8 bits or 16 bits and the number of channels i.e. Mono or Stereo may also be set.

The Image-View 730 also is able to upload to the CIS 140 the edited patient information or comments made in the form of ROI markings, audio recordings, text and/or video recordings. This is done by selecting the upload button 7330. The edited information and/or comments is first saved into a separate local folder. The saved information is then uploaded to the CIS 140 by performing a web request. At the CIS 140, the information that is uploaded from the smart mobile phone 110, 112 or 118 is saved under a folder named with the QUID of the smart mobile phone 110, 112 or 118. This folder is created under a main folder of the database 230 which contains the original patient information.

Audio-Video View 740

Referring now to FIG. 8d, FIG. 8d shows the Audio-Video View 740 of the program 340. The Audio-Video View 740 is the last view in the sequence. The Audio-Video View 740 contains a table 7410 with audio clippings and videos comprised in the patient information. For example, the video may show the response of the patient who is afflicted by a stroke. The clinician is free to browse the list of audio-video files contained in the table and select the file that is of interest to him. The selected clip is then played in a built-in media-player.

The Audio-Video View 740 is implemented using the UITableViewController and uses the UITableView and the object to store patient information. The implementation of the Audio-Video View 740 may be similar to the implementation of the EMR Table-View 710.

FIG. 8e shows the playback of a video file in the Audio-Video View 740 of the program 340. While standard media formats are support by the built-in media player, other formats may be supported by a process of conversion and/or interpretation. Audio and/or video files are played using the built-in media player which is part of the iPhone SDK. In order to allow this, the MediaPlayer frame-work is added in order to permit the invocation of the media player and control the media player. The playback of a media file is achieved using the command:
mediaPlayer.playback(mediafilename);

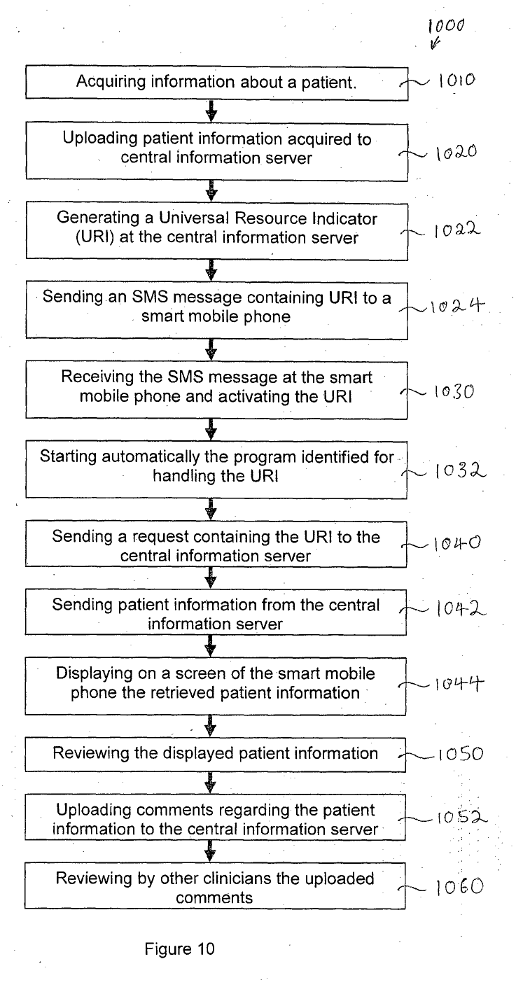

An embodiment of a method 1000 of conducting telemedicine using the system 100 of FIG. 1 is described next with the aid of FIG. 10. FIG. 10 shows the method 1000 of conducting telemedicine using the system 100 of FIG. 1.

In step 1010, information is acquired about a patient. This may be performed during an emergency situation in an ambulance or an Accident & Emergency (A&E) department of a hospital. This may also be performed in a non-emergency situation in the wards of a hospital. The clinical information is acquired using information acquisition devices which may be mobile or immobile.

The clinical information acquired comprises multimedia information such as video or audio recordings of a patient, image data such as a CT scan, vector data such as series of ECG readings, or vital parameters such as a blood pressure reading, sugar level or pulse of a patient. The vital parameters may be contained in the form of a text file. In the case of an emergency, information such as the CT scan image or the video or audio recordings may be useful for strokes, and ECG readings may be useful for cardiac ailments.

In step 1020, the clinical information acquired is uploaded to the CIS 140. A communications link is established to the CIS 140 in order to upload the clinical information. In acquisition devices which have in-built communications capabilities or devices which are linked via an interface e.g. an iPhone dock-port interface to an external mobile device to gain communications capabilities, the communications link may be established directly from the acquisition device to the CIS 140. In devices without communications capabilities, the acquired information may be transferred to an internet enabled device such as a laptop, a notebook PC or a conventional PC for transfer on to the CIS 140.

Access to the CIS 140 may be made through a wired network, a Wi-Fi network or a mobile network using 2.5G/3G mobile technology such as GPRS or UMTS.

The clinical information to be uploaded is zipped, archived or compressed into a single file. The file is then uploaded to the CIS 140. As only a single file is uploaded, this may have the advantage of producing greater ease of use as the uploading of multiple files or images at the same time may be tedious. As an example of the latter advantage, it may be difficult to be uploading multiple attachments in a single e-mail in a single go as there is a need to attach the files one by one.

In order to prevent spurious uploads, each acquisition device logs in to the CIS 140 before uploading its information. The login and password of each user is encrypted and stored in a database. The details from the database are used to authenticate each login.

When uploading the file into the CIS 140, a selection is made to indicate the clinician who should review the information. This may be a selection by a human user, or may be an automatic selection made for example depending on the medical condition experienced by the patient. Further, the selection may be made off a list of all experts in a particular field.

Optionally, multiple clinicians may be selected by selecting broad clinician categories. The categories may group clinicians according to their specialties such as e.g. neuro-surgery or radiology and this information is stored in the database 230. By selecting a category, SMS messages are sent later in step 1024 to each clinician listed in that category. There is also a provision to send an SMS message to an “others” category, i.e. a category comprising clinicians whose specialties do not fit into any of the other categories.

The clinical information that is uploaded is stored in the CIS 140 alongside any existing information about the patient to collectively form patient information. The patient information that is resident on the CIS 140 may also be used to prepare the hospital for treating and receiving the patient when the ambulance arrives.

In step 1022, the CIS 140 generates a Universal Resource Indicator (URI) which indicates the location at which the patient information resides. An example of a possible URI may be a Universal Resource Locator (URL) of the form “mbaceapp://192.168.10.10/datasetname”.

Optionally, in the case where the clinical information uploaded to the CIS 140 is of a format that is not compatible for display on the smart mobile phones 110, 112 and 118, a conversion may be performed by the CIS 140 to convert the information into a compatible format. Taking for example scan images of the DICOM format, these images are converted to the TIFF format so that they are compatible with the smart mobile phones 110, 112 and 118.

In step 1024, an SMS message is sent to the smart mobile phone of the selected clinician. The SMS message contains the URI that is generated in step 1022. The SMS message is pushed from the CIS 140 by way of an SMS gateway. This SMS gateway may be co-located with the CIS 140, or may be hosted away from the CIS 140. The SMS message is delivered from the SMS gateway to the smart mobile phone of the selected clinician across a mobile telephony network.

In step 1030, the clinician receives the SMS message at the smart mobile phone and activates the URI contained in the SMS message. The URI has a URI scheme indicator. Taking the URL of “mbaceapp://192.168.10.10/datasetname” as an example, the URI scheme indicator is “mbaceapp://”. The URI scheme indicator identifies a program 340 that is configured to handle the URI.

In step 1032, the program 340 that is identified for handling the URI is started automatically on the smart mobile phone. Using the earlier URL example, in the case where the smart mobile phone is an iPhone, the application which is associated with the URI scheme indicator “mbaceapp://” is automatically launched. The identification of a program 340 for handling the URI, as well as the automatic starting of the program 340 may confer the advantage of speeding up the process of contacting the clinician. This may also improve the speed in which patient information is pushed to the clinician and may improve the ease of use.

In step 1040, the program 340 sends a request containing the URI to the CIS 140 in order to retrieve the patient information. In the same step, the smart mobile phone also identifies and authenticates itself with the CIS 140. This step is done over a data network such as a Wi-Fi network, a Wi-MAX network or a mobile network using 2.5G mobile technology such as GPRS or a 3G network using for example Universal Mobile Telecommunications System (UMTS).

The request contains a device ID which is used for identifying the smart mobile phone and authenticating access to the patient information. The device ID is unique to each device and may comprise the International Mobile Equipment Identity (IMEI) number. The device ID may also further comprise the phone number. The latter provides an added level of security. In the case where the smart mobile phone is an iPhone, the device ID is various referred to as a Universally Unique Identifier (UUID).

In step 1042, if authentication is successful in step 1040, the CIS 140 sends the patient information to the smart mobile phone over the data network. The patient information may comprise comments and observations made by other third-party clinicians. Further, should the patient have an existing medical record, the patient information may further comprise the medical record or history of the patient.

The patient information that is sent may be a subset of the patient information that is uploaded to the CIS 140 in step 1020. Taking as an example the case where a DICOM image is uploaded to the CIS 140 in step 1020. The image contains a first portion with metadata containing details of patient, image specifications and image acquisition details, and a second portion with the image itself. The metadata of the first portion may be extracted at the CIS 140 into a text file and be sent to the smart mobile phone separately from the second portion. This may facilitate the handling of large datasets and thus may reduce the strain posed on network resources.

The steps of 1024 to 1040 may be seen to be a “push” of patient information from the CIS 140 to the smart mobile phone 110, 112 or 118.

In step 1044, the retrieved patient information is displayed on a screen of the smart mobile phone 110, 112 or 118. This is done by the program 340 which shows the patient information across a number of views, where each view is associated with a particular mode of information—the program 340 has a view for electronic medical records (EMR), a view for text information, another view for image information and yet another view for audio-video information. The patient information that is displayed is multimodal and multimedia in nature. This may help the clinician to better understand the situation of the patient.

In step 1050, the clinician reviews the displayed patient information and makes comments about the information. The comments comprise edited patient information, observations as well as regions of interest (ROI) indicated upon the patient information. In the case where the smart mobile phone is an iPhone, the ROIs may be made freehand, or may be a line, or may take on the shape of a rectangle or an ellipse.

The comments are multimodal in that in the case where the clinician makes an observation about an image, the clinician may make the observation in the form of drawing an ROI indicating an affected area on the image, as well as including text and audio remarks.

In step 1052, the smart mobile phone uploads the comments onto the CIS 140. This may be done automatically by the program 340, or the clinician may have to actively start the upload. In the case where the patient does not have an existing medical history or have any existing comments associated with the patient information, the comments that are uploaded serves to create a new medical record for the patient.

In step 1060, the comments uploaded onto the CIS 140 are available for review by other clinicians. This may permit a live discussion forum between clinicians attending to the patient. The observations, edited patient information and indicated ROIs are shared between clinicians when each clinician retrieves updated patient information from the CIS 140. Clinicians may then build upon the comments of another clinician and post their new comments onto the CIS 140. This may facilitate the conduct of a parallel review of a case, and may further allow a multi-disciplinary collaboration between multiple experts each specializing in a different domain, for example a collaboration between a radiologist and a neurosurgeon.

In the case where existing comments or medical history are already present for a patient, the new comments are appended onto the existing comments or medical history. Optionally, the program 340 may automate the retrieval of updated patient information by repeating the steps 1040, 1042 and 1044 at regular intervals, e.g. once every 30 seconds.

It is envisaged that in alternative embodiments, other messaging systems, e.g. email or instant message, may be used in steps 1024 and 1030 in place of an SMS message. Taking the example of where email is used, in step 1024, the URI generated at the CIS 140 in step 1022 may be sent to the smart mobile phone of the selected clinician as an email message. In step 1030, the clinician receives the email message on the smart mobile phone 110, 112 or 118. In this case, an email gateway may also be used at the CIS 140 instead of a SMS gateway 220.

Further, it is envisaged that the smart mobile phones 110, 112 and 118 may use a single communications network to both receive a message from the CIS 140, as well as retrieve the patient information from the CIS 140. In such a case, the message may be sent from the CIS 140 in step 1024 over a communications network and be received in step 1030 at a smart mobile phone 110, 112 or 118 over that communications network. The smart mobile phone 110, 112 or 118 may then in step 1040 send the request containing the URI to the CIS 140 over the same communications network as that used in step 1030 and in step 1042, the CIS 140 sends the patient information to the smart mobile phone 110, 112 or 118 over that communications network. Such a single communications network may for example be a Wi-Fi, 2.5G (GPRS) or a 3G (UMTS) network.

In alternative embodiments, it is envisaged that the smart mobile phones 110, 112 and 118 additionally may operate in a standalone mode where the smart mobile phones 110, 112 and 118 operate purely to only retrieve patient information that is already resident in the CIS 140. The standalone mode may act as a non-synchronous and non-real-time telemedicine framework using only the CIS 140 and the smart mobile phones 110, 112 and 118. In combination with the web-server 210 and SMS gateway 220, the program 340 running on the smart mobile phones 110, 112 and 118 may permit the clinician to browse, view, edit and record observations on an existing patient record. Such a standalone mode may allow the smart mobile phones 110, 112 and 118 to be used as a teaching aid where an instructor is able to demonstrate the analysis of information in a classroom.

In alternative embodiments, it is also envisaged that the CIS 140 may perform editing of the patient information resident in it. This may be done by a user at the CIS 140, or may be done automatically using some algorithm that runs in the CIS 140.

A further possibility is for the smart mobile phones 110, 112 and 118 to be used in a non-emergency setting as a way to evaluate results. Ground truths may be generated on the move by a person viewing patient information.

Whilst example embodiments of the invention have been described in detail, many variations are possible within the scope of the invention as will be clear to a skilled reader.

1. A method for reviewing at a mobile device patient information residing on a server, the method comprising the steps of
receiving a message from the server, the message having a resource identifier associated with the patient information;
retrieving the patient information from the server using the resource identifier;
displaying at least part of the retrieved patient information on a screen of the mobile device;
reviewing the displayed patient information to obtain a comment; and
uploading the comment to the server.

2. The method according to claim 1 wherein the message is pushed from the server.

3. The method according to claim 1 wherein
the message is received over a first communications network; and
the patient information is retrieved over a second communications network, the second communications network being a different network from the first communications network.

4. The method according to claim 3 wherein the first communications network has a wider coverage than the second communications network.

5. The method according to claim 4 wherein the first communications network is selected from the group consisting of:
a SMS network; and
an email network.

6. The method according to any of claims 3 to 5 wherein the second communications network has a greater bandwidth than the first communications network.

7. The method according to claim 6 wherein the second communications network is selected from the group consisting of:
a Wi-Fi network;
a GPRS network; and
an UMTS network.

8. The method according to any preceding claim wherein the step of retrieving the patient information from the server comprises the step of sending a request to the server, the request including the resource identifier and an authentication code uniquely, identifying the mobile device.

9. The method according to claim 8 wherein the authentication code comprises one or more fields selected from the group consisting of:
an IMEI number of the mobile device;
a phone number; and
a UUID extracted from the mobile device.

10. The method according to any preceding claim wherein
the resource identifier comprises a scheme indicator which identifies a program for retrieving the patient information, wherein a user of the mobile device can initiate the program using the scheme indicator; and
the steps of retrieving the patient information and displaying at least part of the retrieved patient information are performed by the program.

11. The method according to claim 10 wherein the scheme indicator is a prefix of the resource identifier.

12. The method according to claim 10 or 11 further comprising the step of
editing the displayed patient information with the program.

13. The method according to any of claims 10 to 12 wherein the step of displaying at least part of the retrieved patient information includes displaying at least part of the retrieved medical information across multiple views.

14. The method according to any of claims 10 to 13 wherein the steps of retrieving the patient information and displaying at least part of the retrieved patient information are repeated at regular intervals.

15. The method according to any of claims 10 to 14 wherein the patient information further comprises a third-party comment that is uploaded to the server from a further mobile device, the third-party comment being based on patient information retrieved by the further mobile device.

16. The method according to any preceding claim wherein the comment is selected from the group consisting of:
a region of interest marked on the displayed patient information;
an audio recording; and
text.

17. The method according to any preceding claim wherein the method further comprises the steps of
acquiring at another mobile device clinical information from a patient; and
uploading the acquired clinical information to the server to form at least part of the patient information.

18. The method according to any preceding claim wherein the patient information is selected from a group consisting of:
video;
image;
text; and
audio.

19. A mobile device for reviewing patient information residing on a server, the mobile device comprising
a receiver configured to receive a message pushed from the server, the message having a resource identifier associated with the patient information;
a processor configured to retrieve the patient information from the server using the resource identifier;
a screen configured to display at least part of the retrieved patient information; and
a transmitter configured to upload a comment to the server, the comment being obtained from reviewing the displayed patient information.

20. A method for sending patient information from a server to a mobile device, the method comprising the steps of at the server:
generating a resource identifier which is associated with the patient information;
sending a message having the resource identifier to the mobile device;
receiving from the mobile device a request comprising the resource identifier;
sending the patient information to the mobile device; and
receiving a comment from the mobile device, the comment being obtained from at least part of the sent patient information.

21. The method according to claim 20 wherein
the message is sent over a first communications network; and
the patient information is sent over a second communications network, the second communications network being a different network from the first communications network.

22. The method according to claim 21 wherein the first communications network has a wider coverage than the second communications network.

23. The method according to claim 21 or 22 wherein the second communications network has a greater bandwidth than the first communications network.

24. A method for the parallel reviewing of patient information residing on a server, the method comprising the steps of
receiving at a plurality of mobile devices a message pushed from the server, the message having a resource identifier associated with the patient information; and
at each of the plurality of mobile devices
(i) retrieving the patient information from the server using the resource identifier;
(ii) displaying at least part of the retrieved patient information on a screen of each of the mobile devices;
(iii) reviewing the displayed patient information to obtain a comment; and
(iv) uploading the comment to the server.

25. A method according to claim 24 further comprising the step of
at one of the plurality of mobile devices
(v) retrieving from the server the comment uploaded to the server by another of the plurality of mobile devices.

26. A method for reviewing at a mobile device a medical image of a patient, the medical image residing on a server, the method comprising the steps of
retrieving the medical image from the server;
displaying at least part of the retrieved medical image on a screen of the mobile device;
reviewing the displayed medical image to obtain a comment; and
uploading the comment to the server.

27. A method for reviewing, at a mobile device patient information residing on a server, the method comprising the steps of
retrieving the patient information from the server;
displaying at least part of the retrieved patient information on a screen of the mobile device;
reviewing the displayed patient information to obtain an audio comment; and
uploading the audio comment to the server.

28. A method for telemedicine comprising the steps of
acquiring at a first mobile device clinical information from a patient;
uploading the acquired clinical information to a server to form at least part of patient information resident on the server;
receiving at a second mobile device a message pushed from the server, the message having a resource identifier associated with the patient information;
retrieving the patient information from the server using the resource identifier;
displaying at least part of the retrieved patient information on a screen of the second mobile device;
reviewing the displayed patient information to obtain a comment; and
uploading the comment to the server.
